(19) United States
(12) Patent Application Publication
(10) Pub. No.: US 2022/0176915 A1
(43) Pub. Date: Jun. 9, 2022

(54) ALTERNATIVE WINDSHIELD CLEANING SYSTEM

(71) Applicant: VALEO NORTH AMERICA, INC., Troy, MI (US)

(72) Inventor: Mirna Ernestina SANTOYO MARTINEZ, Auburn Hills, MI (US)

(73) Assignee: VALEO NORTH AMERICA, INC., Troy, MI (US)

(21) Appl. No.: 17/114,623

(22) Filed: Dec. 8, 2020

(51) Int. Cl. B60S 1/54; B60S 1/32

(52) U.S. Cl. CPC B60S 1/54; B05D 5/08; B60S 1/32

(57) ABSTRACT

The present invention pertains to an automotive vehicle windshield cleaning system for cleaning outer windshield surfaces by an alternative means to wiper blades. The alternative windshield cleaning system includes a windshield component that applies a nano-hydrophobic coating or photocatalytic coating. A plurality of nozzles are arranged near the windshield periphery to spray or distribute generated compressed air. A control valve controls compressed air flow to the plurality of nozzles and regulates compressed air flow. A control unit operably connects and controls valving based on information received from one or more sensors. The control valve regulates compressed air flow towards the plurality of nozzles. Nozzles spray or direct compressed air onto a windshield's outer surface to remove extraneous elements residing on or along windshield surfaces.

### FIELD OF THE INVENTION

The present invention relates to a windshield cleaning system for a windshield of an automotive vehicle. More particularly, the present invention relates to a windshield cleaning system for cleaning an outer surface of the windshield as an alternative to conventional wiper blade systems.

### BACKGROUND

Windshields are an integral part of automotive vehicles. Windshields are fixed on the vehicle body between the bonnet and the roof to prevent external factors such as wind, dust and rain from disturbing the visibility and adversely affecting the operator's driving of the automotive vehicle. Windshield designs have continuously evolved over years and have undergone major changes to meet vehicle safety and styling requirements. But in spite of these changes, windshields have remained prone to gather dust or other organic matters that hamper operator visibility during automotive vehicle operation. In addition, the remaining water present on the windshield during rain causes irritation, worry or discomfort and visibility issues to the operator. Thus in all conditions, a clean windshield is a paramount requirement in terms of safety. As is conventionally typical, an automotive vehicle is provided with a windshield cleaning system via wiper blades and washer fluid spray for cleaning the windshield of the vehicle.

Known windshield cleaning systems include a wiper system having multiple wiper blades, which are used for cleaning windshields. Wiper blades are arranged on a wiper arm, which is adapted to move the wiper blades to and fro along the windshield surface for cleansing the windshield and keeping it free of debris. Wiper blades of these conventional systems are effective in removing water and light dust particles from the surface of the windshield. But in situations where organic matter or a large contaminant accumulation is present on the windshield, the cleaning effectiveness of wiper blades is limited. Instead, wiper blades in these cases smudge and spread contaminants on the windshield rather than removing them completely or leaving windshield surfaces particle-free. Furthermore over extensive periods, wiper blades (predominantly made of rubber) tend to deteriorate from environmental conditions and extended exposure. Such wiper blade deterioration reduces wiper cleaning efficiency and effectiveness. Furthermore, in some cases, worn-out wiper blade usage contributes to a safety issue due to insufficient cleaning of extraneous elements off the windshield that can damage the windshield also. In addition, a wiper system's wiper blade movements tend to distract the vehicle operator periodically. Thus, wiper blade-based cleaning systems have several limitations where their reduced effectiveness and tendency over a prolonged period occurs due to blade deterioration.

Alternative means for cleaning automotive windshields have been proposed where a windshield's external surfaces are coated with a hydrophobic or nano-hydrophobic coating. The hydrophobic coating has water-repelling properties such that water particles run off or roll down the windshield surface. In turn, hydrophobic coated windshields use the vehicle's aerodynamics to aid in windshield cleaning using ambient atmospheric airflow. This technique of cleaning is efficient at low vehicle speeds or if the vehicle is stationary, as a conventional system is not able to rapidly clean a windshield without the aid of atmospheric airflow. In addition, the atmospheric airflow alone is not very effective for clearing larger organic contaminates. Thus, there is a need for an alternative windshield cleaning system that effectively cleans windshields by overcoming drawbacks of the prior known solutions.

The inventive concept herein overcomes the multiple problems and shortcomings of the conventionally affected windshield cleaning systems and generally known associated limitations that hinder effective cleaning of existing vehicle windshields.

The “background” description provided herein is for purposes of presenting the general context of the disclosure. Work of the presently named inventors, to the extent it is described in this background section, as well as aspects of the description, which may not otherwise qualify as conventional art at the time of filing, are neither expressly nor impliedly admitted as conventional art against the present disclosure.

### SUMMARY OF THE INVENTION

The present invention is directed to a unique solution that addresses at least one or more of the described issues in paragraphs above. It is believed that the windshield cleaning system of the present invention can effectively clean the windshield with either hot air or cold air depending on environmental temperatures and achieve the objectives with a high efficiency over a prolonged period of time. Furthermore, the proposed windshield cleaning system can effectively clean windshields without the use of any external mechanical devices (for example, wiper blades). In addition, the present invention's windshield cleaning system of is capable of effectively cleaning windshields even if large contaminants are present or accumulated residing on the windshield. Moreover by implementing the present invention's windshield cleaning system, noise, wiper chatter, accumulated matter, water patches and the like resulting from or are produced by wiper blade usage may be avoided.

Accordingly, pursuant to a first aspect of the present invention, there is contemplated a windshield cleaning system comprising: a nano-hydrophobic coating and photocatalytic coating, which is applied on an outer surface of a windshield of an automotive vehicle; a plurality of nozzles that are arranged near the periphery of the windshield: a control valve arranged in an air line between an air source and the plurality of nozzles; wherein the air source generates a compressed air source; a control unit operably connects the control valve and the compressed air source for automated operation of the control valve and the compressed air source; wherein the control valve operates to change from a closed position to an open position to allow the flow of compressed air towards the plurality of nozzles to spray the compressed air onto the outer surface of the windshield along an air flow axis to remove extraneous elements present therein, in response to an activation signal from the control unit; and wherein the windshield cleaning system further comprises one or more sensors operably connected with the control unit and the compressed air source.

The invention may be further characterized by one or any combination of the features described herein, such as; wherein the control unit activates the control valve and the compressed air source based on at least one of information received from one or more sensors, and in response to the activation of the windshield cleaning system, wherein the compressed air source is adapted to be activated in response to detection of extraneous elements by the one or more sensors, and adapted to generate an amount of hot compressed air or an amount of cold compressed air based on a source of information received from the one or more sensors; wherein the one or more sensors include at least one of a rain sensor, a moisture sensor, a temperature sensor or an optical sensor, where the one or more sensors are configured to detect the presence of extraneous elements on the surface of the windshield and to send information to the control unit; wherein the information sent by the one or more sensors to the control unit includes at least one of a presence or a size of rain droplets by the rain sensor, an amount of humidity by the moisture sensor, atmospheric temperature by the temperature sensor or a presence of dust or organic matter by the optical sensor.

The invention may further be characterized by one or any combination of the features described herein, such as, wherein the exit face of each nozzle includes a plurality of orifices configured to spray multiple jets of air towards the outer surface of the windshield; wherein an air nozzle includes a fixation element adapted to be connected to a nozzle mounting adapter such that the air nozzle is positioned at an acute angle relative to the surface of the windshield; wherein the plurality of nozzles are positioned at the bottom or at the top near the periphery of the windshield; wherein the plurality of nozzles are positioned along a number of sides near the periphery of the windshield. Alternatively, some of the plurality of nozzles are positioned at the bottom of the windshield and where other remaining nozzles are positioned along another side of the windshield; and wherein the pitch between two consecutive nozzles is constant.

The invention may further be characterized by one or any combination of the features described herein, such as, wherein the cleaning system includes an air filter that is configured to filter compressed air; the windshield cleaning system includes a temperature regulator arranged in the air line between the compressed air source and the control valve for regulating the temperature of the compressed air that flows towards the plurality of nozzles through the control valve; wherein the photocatalytic coating on the windshield glass panel is titanium dioxide; wherein one or more nozzles of the plurality of nozzles are selectively operated by the control unit based on the information from the one or more sensors; wherein the one or more nozzles operate simultaneously to project the high pressure air onto the outer surface of the windshield; wherein the plurality of nozzles are arranged at the bottom of the windshield and some remaining nozzles are arranged on or along a side of a wiper blade; wherein each nozzle is adapted to generate a fan-shaped spray during vertical projection onto the windshield.

Accordingly, pursuant to a second aspect of the present invention, contemplated is a method of cleaning a windshield of a vehicle, the method comprising applying a nano-hydrophobic coating or a photocatalytic coating on the windshield; receiving information from one or more sensors configured to indicate the presence of an extraneous element present on the windshield; activating a compressed air source in response to detection of extraneous elements by the one or more sensors; activating a control valve by a control unit in response to the information received from the one or more sensors, wherein the control valve arranged in an air line between a compressed air source and a plurality of nozzles; and wherein the control valve is operable to move between closed and open positions to control the a flow of compressed air through the air line; and in response to the activation of the control valve, changing the position of the control valve from the a closed position to the an open position to allow the flow of compressed air towards the plurality of nozzles that are configured to spray the compressed air onto the outer face of the windshield along an air flow axis to remove extraneous elements present thereon.

Accordingly, pursuant to a third aspect of the present invention, contemplated is a wiper system of an automotive vehicle comprising a wiper blade assembly; a wiper arm assembly; a linkage mechanism; and a windshield cleaning system comprising: a nano-hydrophobic coating or a photocatalytic coating, which is applied on an outer face of a windshield of an automotive vehicle; a plurality of nozzles arranged at a bottom of the windshield; a number of control valves arranged in an air line between a compressed air source and each nozzle of the plurality of nozzles; one or more sensors operably connected with a compressed air source; a control unit that operably connects the number of control valves and the compressed air source for automated operation of the control valves; wherein the control unit is configured to select one or more nozzles from the plurality of nozzles for an operation based on the information from the one or more sensors; and wherein the control valve changes from a closed position to an open position to allow a flow of compressed air towards one or more nozzles of the plurality of nozzles that are configured to spray the compressed air onto the outer face of the windshield along an air flow axis to remove extraneous elements present thereon in response to an activation signal from the control unit.

It should be appreciated that the above referenced aspects and examples are non-limiting, as other aspects exist within the present invention, as shown and described herein.

### DESCRIPTION OF DRAWINGS

To further provide a more encompassing description and a better understanding of the invention, a set of drawings is provided. Said drawings form an integral part of the description and illustrate embodiment aspects of the invention, which should not be construed as restricting the scope of the invention, but only as examples of how the invention can be carried out. The drawings comprise the following characteristics:

FIG. 1 shows a windshield cleaning system, according to an embodiment of the present invention.

FIG. 2 shows a projection of fluid (air) from a plurality of nozzles associated with the windshield cleaning system of the FIG. 1, according to an embodiment of the present invention.

FIG. 3 shows a windshield cleaning system, according to another embodiment of the present invention.

FIG. 4 illustrates a method of cleaning the windshield of an automotive vehicle by using a windshield cleaning system, according to an embodiment of the present invention.

FIG. 5 shows a windshield cleaning system, according to another embodiment of the present invention.

FIG. 6 shows a windshield cleaning system, according to another embodiment of the present invention incorporating wiper arm-blade-linkage assembly.

### DETAILED DESCRIPTION OF PREFERRED EMBODIMENTS

Windshields are attached to a window frame of an automotive vehicle for enhancing operator visibility and comfort during vehicle operation. It is paramount to keep the vehicle's windshield clean under all operating conditions. For this purpose, automotive vehicle windshields are provided with windshield cleaning systems for removing extraneous elements namely rain droplets, dust, or organic material from windshield surfaces.

The present invention provides a windshield cleaning system that can effectively clean the windshield with hot or cold air depending on environmental temperatures and with a high efficiency over a prolonged period of time. Furthermore, the proposed windshield cleaning system can effectively clean the windshield without the use of any external mechanical devices, for example, wiper blades. In addition, the windshield cleaning system of the present invention is capable of effectively cleaning the windshield even if the large contaminants are present on the windshield. Also, by using the windshield cleaning system of the present invention; noise, chatter, water patches and the like produced from wiper blade usage can be avoided.

Unless defined otherwise, all technical and scientific terms used herein have the same meaning as commonly understood by one of ordinary skill in the art to which this technology belongs.

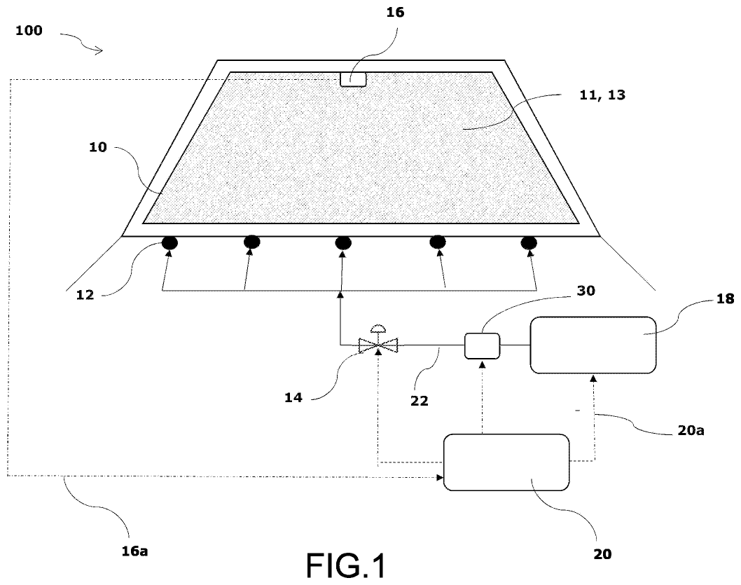

Of particular interest and a main focus of the present disclosure is to provide a windshield cleaning system for an automotive windshield as shown in FIG. 1. FIG. 1 shows a windshield cleaning system, according to an embodiment of the present invention. Windshield cleaning system 100 shown in FIG. 1 comprises a windshield that has applied a nano-hydrophobic 11 and photocatalytic coating 13, a plurality of nozzles 12, a control valve 14, one or more sensors 16, an air source 18, a control unit 20, and an air line 22. The windshield cleaning system may be placed inside the vehicle body such that it is concealed or not visible from outside.

The windshield cleaning system may be placed relatively in close proximity to the windshield to facilitate cleaning the windshield surface. The control valve 14 of the windshield cleaning system may be arranged in the air line 22 between a compressed air source 18 and the plurality of nozzles 12. Compressed air source 18 may be configured to generate compressed air that may be directed towards the plurality of nozzles 12 through a control valve 14. Further, the one or more sensors 16 may be operably connected with control unit 20 and the compressed air source 18. One or more sensors 16 may include at least a rain sensor, a moisture sensor, a temperature sensor or an optical sensor. The one or more sensors 16 may be placed near the windshield 10 or in some cases on the windshield 10 itself to be able to detect an extraneous element 40 (e.g. moisture, rain, droplet, dust, insect or soil particle) on windshield 10.

Furthermore, control unit 20 may be configured to control the control valve 14 and/or compressed air source 18 based on the source of information from one or more sensors 16. In addition, air line 22 may be configured to mechanically connect the compressed air source 18, control valve 14 and the plurality of nozzles 12 to allow the flow of compressed air.

In another embodiment of the present invention, windshield cleaning system 100 includes a temperature regulator 30 arranged in the air line 22 between compressed air source 18 and control valve 14.

It is contemplated that the relationship between components and corresponding component assemblies are surprisingly important in solving one or more issues described in the background section above. Each of the components and associated assemblies and their relationships are disclosed in greater detail and specificity by the following paragraphs.

### Windshield 10

Windshield(s) 10 represents a front, rear or exterior window of an automotive vehicle used for providing visibility to vehicle occupants while shielding occupants from an exterior environment and from elements such as rain or dust or wind. Windshields may be generally arranged projecting above and across the dashboard of a vehicle. Modern windshields are generally made of laminated safety glass—a type of treated glass, which typically consists of two sheets of glass with a plastic layer laminated between them for safety, which are bonded or joined into a window-frame of a vehicle.

In an embodiment, windshield 10 of the present invention may be applied with a nano-hydrophobic coating 11 and photocatalytic coating 13 on an outer surface of the windshield 10. The photocatalytic coating 13 that may be used for a surface coating may be of a type titanium dioxide coating or a compound-material having similar properties such as light activated microbial agents. The nano-hydrophobic coating 11 that may be applied may be of compound types from alkanes or Polytetrafluoroethylene or the likes.

The hydrophobic and photocatalytic properties of the windshield 10 prevents extraneous elements 40 such as rain droplets or particles [40 may represent ash, dust, mud, soil, insect residue, accumulated matter, etc.] from sticking to a windshield surface. A photocatalytic coating 13 has a beneficial purpose of any organic substance 40 reduction by facilitating degradation of such material 40. So any organic deposit type, such as for instance bird excrement, will just be degraded. And thereby during system operation with resulting air flow, such residues 40 may be removed through the resulting air flow. The photocatalytic coating 13 applied on the windshield 10 helps in removal of organic and inorganic elements due to the light activated microbial properties of the coating. Whereas, the hydrophobic coating 11 helps to remove water or rain droplets [40 may be represent moisture-based matter, snow, ice, rain by example] from the surface of the windshield 10. The hydrophobic coating 11 on the surface of the windshield 10 acts as a moisture-repellant layer preventing extraneous elements 40 such as rain droplets from sticking on the surface. Small quantities of particles or water droplets present on the surface of the windshield 10 may be carried by air passing over the surface of the windshield when the vehicle is moving preventing accumulation of contaminants along or on the windshield surface. Any dust or liquids interfacing the windshield 10 should just be disbursed or runoff due to the hydrophobic coating 11. The photocatalytic 13 and hydrophobicity 11 of windshield 10 will be applied active in operation at all times due to the photocatalytic condition 13 as applied on windshield 10, which will promote degradation of any organic substance 40 on the windshield's surface. The hydrophobicity 11 will condition windshield 10 to avoid the permanence of liquid residues and also creates an applied coat against dust 40.

### Compressed Air Source 18

Compressed air source 18 may represent a mechanical device used to increase fluidic pressure through air volume reduction. Compressed air source 18 typically includes a compressor. Compressors are typically driven either by a mechanical power source such as an engine or by an electric power source such as electric motors. Compressors may be broadly classified as a positive displacement compressor and a dynamic compressor. Some compressor types may include reciprocating compressor, rotary vane compressor, centrifugal compressor, etc. In automotive vehicles, compressors are usually found placed inside an engine bay and may be powered by the vehicle's engine or by an electric motor. In vehicles, compressors are predominantly used in HVAC systems to move and exchange heat in refrigerant cycles.

### Plurality of Nozzles 12

Nozzles 12 represent devices used for controlling the direction and characteristics of fluidic flow. Nozzles are adapted to receive the compressed air generated from the compressed air source. Nozzles usually have a varying cross sectional area used to direct or modify the flow of fluids. Nozzles may differ based on the functional purpose and application, such as jet nozzles intended to eject gas, high velocity nozzles or spray nozzles that are precision devices to facilitate dispersion of liquids into a spray state over an expansive area. Nozzles are generally connected to a fluid source such as a compressed air source by means of conduits or ducts or pipes. Generally, nozzles may have an exit face that is smaller than an input face of the nozzle. The exit face of nozzles may include a circular profile, but in some cases other profiles such as a rectangular or triangular shapes can also be used. In some nozzles, an exit face may be provided with plurality of orifices to squirt multiple jets of fluid.

### Sensor 16

Sensor 16 represents a device that measures physical input from its environment and converts it into data that can be interpreted by either a human or machine. Most sensors are electronic modules used to detect events or changes in an environment and send the information to other electronic devices such as a computer processor or a control unit. The information sent by the sensor to the control unit in order to control or produce an effective output can be termed as sensor information 16a. There are two types of electronic sensors: analog and digital. Many types of sensors are available in an automotive vehicle, and some examples of the vehicle's sensors include a rain sensor that detects the presence of rain droplets on a surface, a temperature sensor that detects the atmospheric temperature, tire pressure monitoring sensor etc. Typically, these sensors are provided near the windshield or in some cases placed on the windshield itself. Sensors 16 associated with the windshield cleaning system via an optical, rain or thermic means, for instance, will detect changes on the windshield 10 which will trigger or promote the action of the system. With ice presence, the system may be activated by a temperature sensor or an optical sensor designed to activate hot air for ice removal which may be ideally combined with lower windshield surface adherence features derived from the hydrophobic coating 11 characteristics.

### Control Valve 14

Control valve 14 represents a device used to control fluidic flow by controlling the fluid flow passage. This function enables direct control of flow rate and direction through the control valve. The opening or closing of the control valves are usually done by an electrical, a hydraulic or pneumatic actuators. Normally, a valve can be set to any position between fully open and fully closed to ensure the valve attains the desired degree of opening to regulate the flow rate. The control valve used to control the flow of compressed air may be an electro-mechanically operated valve such as a solenoid valve. Solenoid valves have many advantages such as enabling fast and safe switching, possessing high reliability, extended service life and are compact in design.

### Control Unit 20

Control unit 20 represents a device that directs the operation of other electronic units by providing timing and control signals. The control unit is typically connected to sensors to receive information for processing. The control unit receives an input information and converts it into control signals that supervises the execution of instructions programmed in the internal memory of the control unit. Control signals that are sent to activate the hardware to carry out certain tasks may be generally indicated as activation signals 20a. Some examples of control units include Engine Control Unit (ECU, for controlling automotive engine parameters) or a control unit for lighting functions of a matrix lighting device, etc.

### Temperature Regulator 30

Temperature regulator 30 represents a device used to control the temperature of fluid flow, in response to temperature changes in the fluid, such as compressed air based on the requirements. Temperature regulation usually involves either heating or cooling the fluid. Temperature regulation involves heating by an electric heater or similar devices to increase the temperature and may involve pressure balancing mechanism and a thermostat.

### Air Line 22

Air line 22 represents a pipe or conduit or passages connected to various components in a fluid system to enable fluid flow between components. For example, the air line may connect a compressed air source and a plurality of nozzles to allow flow of compressed air from a compressed air source to the plurality of nozzles. Air line can usually be flexible or rigid based on the requirement of the flow of fluid such as compressed air. Air line assemblies are usually constructed with the use of fittings such as elbows, tees, and so on and air lines may be made out of many types of material including ceramic, glass, fiberglass, various metals, concrete and plastics. In general commercial or industry usage, air lines may be called pipes or hoses depending on the type.

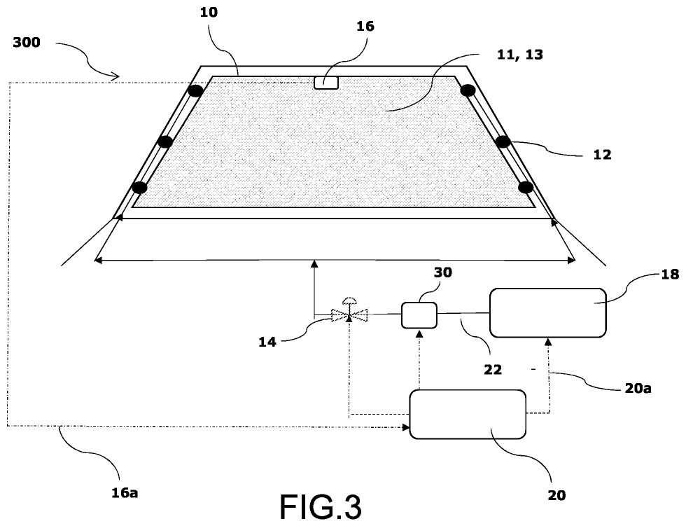

In a FIG. 1 embodiment of the present invention, windshield cleaning system 100 comprises a plurality of nozzles 12 arranged near the periphery of the windshield 10. In a preferred embodiment of the present invention, the plurality of nozzles 12 may be positioned at the bottom or top near the periphery of the windshield 10. In another FIG. 3 embodiment, the plurality of nozzles 12 may be positioned at the side or near the periphery of windshield 10. The arrangement of the plurality of nozzles 12 near the periphery of the windshield enables uniform spread of spray over a wider area.

Furthermore, the plurality of nozzles 12 may include a fixation element (not shown in Figures) adapted to be connected to a nozzle mounting adapter (not shown in Figures). In an embodiment, the plurality of nozzles 12 may be directly fixed onto the vehicle body using the fixation element and the nozzle mounting adapter. In alternative embodiments, the plurality of nozzles 12 may be fixed on a guide rail provided on the vehicle body. The plurality of nozzles 12 may be adapted to receive and spray compressed air generated from the compressed air source 18 on to the surface of the windshield 10.

In another embodiment, compressed air source 18 may be provided inside the engine bay to generate compressed air. The compressed air source 18 may be configured to provide a continuous supply of compressed air to the plurality of nozzles 12 through an air line 22. In addition, compressed air source 18 may be adapted to be activated in response to the detection of extraneous elements by the one or more sensors 16. Upon activation, compressed air source 18 may generate a hot compressed air or a cold compressed air based on the information 16a received from the one or more sensors 16. Hot air may be generated because of compressing the air by the compressed air source 18. The hot compressed air generated by the compressed air source 18 may be used to remove ice or snow from the surface of windshield 10. The hot air generated may help in removing the icing or snow from the windshield surface. In conditions where the ambient temperature is normal or under standard temperature operating ranges, the compressed air source may be configured to generate cold air for the typical windshield cleaning system's operation. For generation of cold compressed air, the heat generated during compression is allowed to be lost to atmosphere and reduces the temperature of the compressed air.

One or more sensors 16 may include at least a rain sensor, a moisture sensor, a temperature sensor or an optical sensor. The one or more sensors 16 may be configured to detect the presence of extraneous elements 40 on the surface of the windshield 10 and send at least one information 16a to the control unit 20. The at least one information 16a sent to the control unit 20 may include at least a presence and size of rain droplets by the rain sensor, amounts of humidity by the moisture sensor, atmospheric temperature by the temperature sensor or a presence of dust and/or organic matter by the optical sensor. The control unit 20 may be configured to detect the amount of extraneous elements present on the windshield and may use the information as indicated from one or more sensor 16. In an example, the rain sensor, which is used to detect the presence of the rain particles on the windshield, may be placed on the windshield preferably behind the internal rear view mirror. The sensor may be configured to detect the presence of the water droplet using principals of total internal reflection. In addition, the moisture sensor may be configured to detect the humidity level in the ambient air and the temperature sensor may be configured to detect the ambient temperature. Control unit 20 may be configured to receive this information to calculate the intensity of rain and accordingly the amount of water droplets present on the windshield. It is well known to persons skilled in the art, how the information from the sensors may be interpreted and processed by the control unit 20 to calculate the intensity and amount of rain droplets.

Control unit 20 may be connected to the automotive electronics and may be configured to be in an active state. In an embodiment, control unit 20 may be configured to operably connect the control valve 14 and the compressed air source 18 for automated operation. Based on at least information 16a as indicated earlier from the one or more sensor the control units 20 may be configured to control various aspects of the windshield cleaning system 100. Accordingly, upon receiving information 16a from the one or more sensors 16, the control unit 20 may be configured to send an activation signal 20a to activate control valve 14 and compressed air source 18. To enable continuous monitoring and control of the windshield cleaning system 100, a closed loop communication or a closed loop control may be provided between control unit 20 and a sensor 16. As shown in FIG. 1, control valve 14 may be arranged in the air line 22 between the compressed air source 18 and the plurality of nozzles 12. Control valve 14 may be configured to operate and change from a closed position to an open position to allow the flow of compressed air towards the plurality of nozzles 12. The position of the control valve 14 may change in response to an activation signal 20a from control unit 20. Activation signal 20a from the control unit 20 may be based on the at least one information 16a received from the one or more sensors 16. In an embodiment, control valve 14 may be configured to control the direction and pressure of the compressed air directed towards the plurality of nozzles 12.

To allow the flow of compressed air between various components of the windshield cleaning system 100, an air line 22 may be provided. As shown in FIGS. 1-3, air line 22 connects the compressed air source 18, the control valve 14 and the plurality of nozzles 12. Air line 22 may be configured to carry the compressed air from the compressed air source 18 to the plurality of nozzles 12 through the control valve 14. Air line 22 may be configured to be flexible to allow movement of the air line 22 relative to other components such as nozzles 12, compressed air source 18 etc. Flexible air line 22 further allows the windshield cleaning system 100 to be packed compactly in the vehicle. In an embodiment, air line 22 may be made of plastic or polymeric materials to avoid damage to the air line 22 due to corrosion and other environmental effects.

In an embodiment of the present invention, for cleaning the surface of the windshield, the control unit 20 of the windshield cleaning system 100 activates the compressed air source 18 to generate compressed air. Activation of the compressed air source 18 by the control unit 20 may be based on information 16a received from a sensor 16 to indicate the presence of extraneous elements 40 such as rain droplets. Compressed air source 18 on activation generates compressed air that is then carried to the control valve 14 through the air line 22. Further, control unit 20 sends an activation signal to the control valve 14 to change the position of the control valve 14 and directs compressed air towards the plurality of nozzles 12. The compressed air may then be configured to be sprayed by plurality of nozzles 12 on to the surface of the windshield. The compressed air may be sprayed with high force to remove the extraneous element from the surface of the windshield 10.

According to another embodiment of the present invention, the control unit 20 activates temperature regulator 30 based on the information from one or more sensors 16 such as an optical sensor or temperature sensor for regulating the temperature of the compressed air flowing towards the plurality of nozzles 12. The information received from the one or more senor 16 may include for example presence of icing or snow on the surface of the windshield 10 by the optical sensor and/or the ambient temperature of the from the temperature sensor. The temperature regulator 30 regulates the temperature of the compressed air produced by the compressed air source 18 to generate hot compressed air. The temperature regulator 30 essentially heats the compressed air to further increase the temperature of the compressed air. As previously indicated, the control unit 20 activates the control valve 14 to direct the hot compressed air towards the plurality of nozzles 12 sprayed on the windshield's 10 surface. The hot compressed air when sprayed on the windshield 10 removes icing or snow present along the surface of the windshield 10.

In an embodiment, each of the plurality of nozzles 12 of the windshield cleaning system 100 of present invention may be a convergent nozzle having an exit face smaller than an input face of the nozzle 12. The smaller profile of the exit face of the nozzles 12 allows the nozzles to spray compressed air at a high pressure and velocity onto the surface of the windshield 10. The size of the exit face of nozzle may be maintained between 0.5 mm to 2 mm depending on the size of spray required. The high pressure and velocity of the compressed air sprayed on the surface of the windshield 10 forcibly removes the extraneous element from the surface of windshield 10.

In another embodiment of the present invention, the exit face of the each nozzle 12 may include a circular profile to spray compressed air towards the surface of windshield 10. The circular profile of the nozzle enables a homogeneous spray covering a larger area on the surface of the windshield 10. In alternate embodiment of the present invention, the exit face of each nozzle 12 may include a plurality of orifices (not shown in Figures) configured to spray multiple jets of air towards the outer surface of the windshield 10.

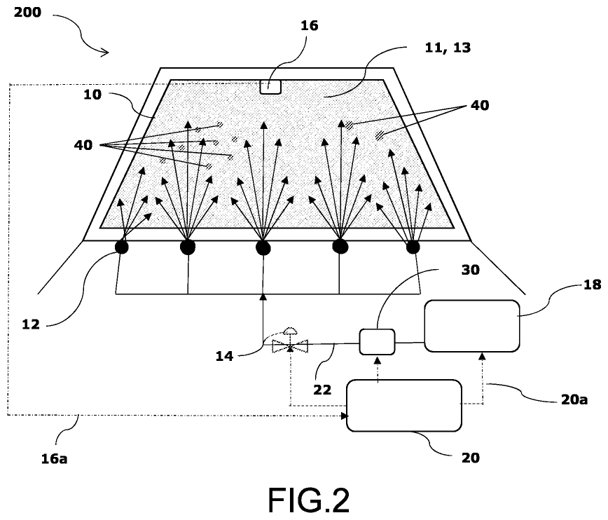

In a preferred embodiment, as shown in FIG. 2, the pitch between the consecutive nozzles 12 may be maintained constant to allow uniform spread of compressed air over the surface of the windshield 10. In addition, the plurality of nozzles 12 may be positioned at an acute angle relative to the surface of the windshield 10. The arrangement of the plurality of nozzle 12 at an acute angle and having constant pitch between consecutive nozzles ensures removal of extraneous element from the entire surface of the windshield 10. The plurality of nozzles 12 may be further configured to sprays the compressed air along an air flow axis to remove the extraneous elements from the windshield 10. The one or more nozzles 12 may operate simultaneously to spray the compressed air onto the outer surface of the windshield 10 to clean the entire surface of the windshield 10.

In another embodiment of the present invention as seen in FIG. 3, the plurality of nozzles 12 may be positioned at the side near the periphery of the windshield 10. In this arrangement the compressed air from the plurality of the nozzles 12, are directed towards the inside of windshield 10. In another embodiment, some of the plurality of nozzles 12 are positioned at the bottom of the windshield 10 and remaining nozzles 12 are positioned along a side of the windshield 10. In an alternate embodiment, each nozzle 12 is adapted to generate a fan-shaped spray during vertical projection onto the windshield.

In an alternate embodiment of the present invention, each of the plurality of the nozzles 12 may be provided with a control valve 14. The control valve 14 may be selectively operated by the control unit 20 to individually control the flow of compressed air to each of the plurality of nozzles 12. The control unit 20 may send the activation signal to the control valve 14 to direct the flow of compressed air towards the specific nozzle 12. The selective operation of the control valve associated with one or more nozzles 12 enables removing extraneous element from a specific region of the windshield 10. In another embodiment of the present invention, the windshield cleaning system 100 may further comprise a filter arranged in the air line 22. The filter may be used to filter the compressed air to remove dust or debris from the compressed air to prevent the blocking of the nozzles 12. In addition, this prevents damage to the windshield surface or the coating applied on the windshield surface due to the unclean air entering the windshield cleaning system 100.

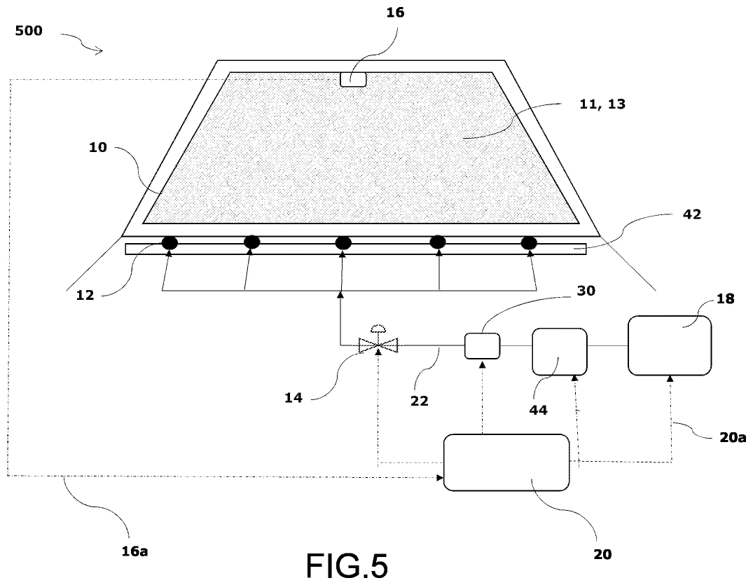

In an embodiment of the present invention, the plurality of nozzles 12 may be fixed on the guide rail 42 (as shown in FIG. 5) and may be movable relatively to the windshield 10. The windshield cleaning system 400 may include a linkage assembly and a motor to move the plurality of nozzles 12 fixed on the guide rail. In an alternate embodiment, the plurality of nozzles 12 may be arranged to be pilotable about the pivot axis of the plurality of the nozzle 12 relative to the windshield. The movement of the nozzles 16 may enable the spray of compressed air to move like a wiper blade relative to the windshield.

In another embodiment, the plurality of nozzles 12 placed at bottom or top near the periphery of the windshield to spray high-pressure compressed air on to the surface of the windshield 10. The force of the compressed air sprayed on the surface of the windshield 10 pushes the extraneous elements 40 away from the surface of the windshield 10 to effectively clean the windshield. The plurality of nozzles 12 when placed at the bottom may push the extraneous elements 40 over the roof of the vehicle and may be aided by the vehicle body's aerodynamics. Similarly, when the plurality of nozzles 12 are placed at the top, cleaning may be aided by gravity as the extraneous elements 40 are pushed downwards. Windshield cleaning system 100 capably cleans the windshield surface without involving mechanical devices as the compressed air is sprayed with high pressure and force ensuring effective cleaning. In addition, the hydrophobic coating 11 or the photocatalytic coatings 13 prevent extraneous elements 40 from sticking onto the surface of windshield 10, hence extraneous elements 40 are easily removed by the compressed air sprayed by the plurality of nozzles 12. The control unit 20 based on the information 16a from one or more sensors 16 calculates the amount of extraneous element 40 and accordingly controls the compressed air source 18 and the control valve 14. Hence, the windshield cleaning system 100 is able to remove even large contaminants 40 and work effectively during heavy rain conditions. Also, by using the windshield cleaning system of the present invention; noise, chatter, accumulated matter, water patches and the like formed in the ordinary course of usage with the wiper blades can be avoided.

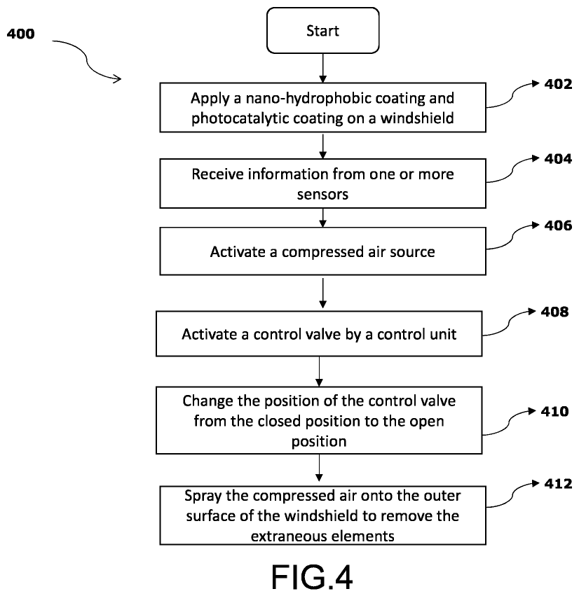

As illustrated in FIG. 4, the method 400 of cleaning a windshield comprises a step 402 of applying a nano-hydrophobic coating 11 and photocatalytic coating 13 on a windshield 10. Each of the applied coating on the windshield 10 may serve to aid in the specific type of extraneous element 40 removal from the surface of windshield 10. For instance, the photocatalytic coating 13 may have light activated microbial properties to remove organic and inorganic materials 40. In addition, the hydrophobic coating 11 may act as a water repellent layer to remove water particles from the surface of the windshield 10. In an aspect, the coating may be applied to the entire surface of the windshield 10. In step 404, the method includes receiving information from one or more sensors 16. In an aspect, the one or more sensors 16 may be configured to detect the presence of extraneous elements 40 on the surface of the windshield 10. In an aspect, sensor 16 may include a rain sensor, a moisture sensor, a temperature sensor and/or optical sensor. The sensors 16 may be further configured to send the information to a control unit 20. In step 406, the method includes activating a compressed sir source 18 to generate a compressed air. Compressed air source 18 may be activated in response to the information received from the one or more sensor 12. In another embodiment, the windshield cleaning system 500 may include a compressed air reservoir 44 (as shown if FIG. 5) to store the compressed air.

In step 408, the method includes activating a control valve 14 by the control unit 20 in response to the information received from the one or more sensors 16. In an aspect, the control valve 14 may be arranged in an air line 22 between the compressed air source 18 and a plurality of nozzles 12. Control valve 14 is operable to move between closed and open positions to control the flow of compressed air through air line 22. In step 410, the method includes changing the position of the control valve 14 from the closed position to the open position. In an aspect, the change in position of the control valve may be in response to the activation of the control valve 14 by the control unit 20. The control valve 14 may allow the flow of compressed air towards the plurality of nozzles 12 through the air line 22. In step 142, the method includes spraying the compressed air onto the outer surface of the windshield 10 along an airflow axis to remove extraneous elements 40 present on the windshield 10.

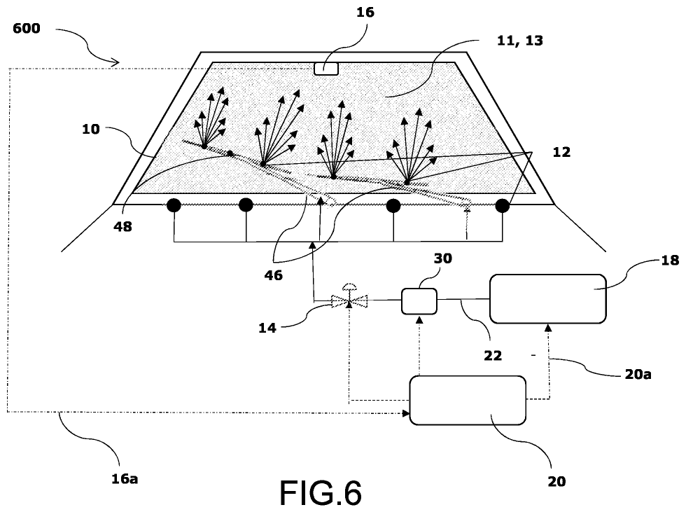

In another embodiment of the invention as shown in FIG. 6, some of the plurality of nozzles 12 are arranged at the bottom of the windshield 10 and remaining nozzles are arranged on a side of a wiper blade 48. The wiper system of this embodiment comprises a wiper blade assembly 46; a wiper arm assembly; a linkage mechanism; and a windshield cleaning system 600 of the present invention as indicated earlier in the application.

Although the present disclosure provides references to figures, all embodiments shown in the figures are intended to explain preferred embodiments of the present invention by way of example rather than being intended to limit the present invention. Preferred embodiments of the present invention have been disclosed. However, it should be apparent to a person of ordinary skill in the art that certain modifications would come within the teachings of this invention and that various changes or modifications may be made in the present disclosure without departing from the principles and spirit of the disclosure, which are intended to be covered by the present invention as long as these changes or modifications fall within the scope defined in the claims and their equivalents.

### LIST OF ELEMENT NUMBERS

Windshield 10
Nano-hydrophobic coating 11
Photocatalytic coating 13
Plurality of nozzles 12
Control valve 14
Sensor 16
Sensor information 16a
Compressed air source 18
Control unit 20
Air line 22
Temperature regulator 30
Extraneous elements/moisture-rain droplet/dust, insect, organic, soil particle 40
Guide rail 42
Air reservoir 44
Wiper arm-blade-linkage assembly 46
Wiper blade 48

What is claimed is:

1. A windshield cleaning system comprising:
a nano-hydrophobic coating and a photocatalytic coating, which is applied on an outer face of a windshield of an automotive vehicle;
a plurality of nozzles arranged near a periphery of the windshield;
a control valve arranged in an air line between an air source and the plurality of nozzles, wherein the air source generates a compressed air source;
a control unit that operably connects the control valve and the compressed air source for automated operation of the control valve and the compressed air source, and
wherein the control valve operates to change from a closed position to an open position to allow a flow of compressed air towards the plurality of nozzles to spray the compressed air onto an outer face of the windshield along an air flow axis to remove extraneous elements present thereon, in response to an activation signal from the control unit, and wherein the windshield cleaning system further comprises one or more sensors operably connected with the control unit and the compressed air source.

2. The windshield cleaning system of claim 1, wherein the control unit activates the control valve and the compressed air source based on at least information received from one or more sensors or in response to the activation of the windshield cleaning system.

3. The windshield cleaning system of claim 1, wherein the compressed air source is adapted to be activated in response to detection of extraneous elements by the one or more sensors, and adapted to generate a hot compressed air or a cold compressed air based on a source of information received from the one or more sensors.

4. The windshield cleaning system of claim 1, wherein the one or more sensors include at least one of: a rain sensor, a moisture sensor, a temperature sensor or an optical sensor, where the one or more sensors are configured to detect the presence of extraneous elements on the surface of the windshield and send information to the control unit.

5. The windshield cleaning system of claim 1, wherein the information sent by the one or more sensors to the control unit includes at least one of: a presence and size of rain droplets by the rain sensor, an amount of humidity by the moisture sensor, atmospheric temperature by the temperature sensor or a presence of dust or organic matter by the optical sensor.

6. The windshield cleaning system of claim 1, wherein an exit face of each nozzle includes a plurality of orifices configured to spray multiple jets of air towards the outer face of the windshield.

7. The windshield cleaning system of claim 1, wherein an air nozzle includes a fixation element adapted to be connected to a nozzle mounting adapter such that the air nozzle is positioned at an acute angle relative to the surface of the windshield.

8. The windshield cleaning system of claim 1, wherein the plurality of nozzles are positioned at the bottom or at the top near the periphery of the windshield.

9. The windshield cleaning system of claim 1, wherein the plurality of nozzles are positioned along a number of sides near the periphery of the windshield.

10. The windshield cleaning system of claim 1, wherein some of the plurality of nozzles are positioned at the bottom of the windshield and where remaining nozzles are positioned along another side of the windshield.

11. The windshield cleaning system of claim 1, wherein the pitch between two consecutive nozzles is constant.

12. The windshield cleaning system of claim 1, wherein the cleaning system includes an air filter that is configured to filter the compressed air.

13. The windshield cleaning system of claim 1, wherein the windshield cleaning system includes a temperature regulator arranged in the air line between the compressed air source and the control valve for regulating the temperature of the compressed air that flows towards the plurality of nozzles through the control valve.

14. The windshield cleaning system of claim 1, wherein the photocatalytic coating on the windshield glass panel is titanium dioxide.

15. The windshield cleaning system of claim 1, wherein one or more nozzles of the plurality of nozzles are selectively operated by the control unit based on the information from the one or more sensors.

16. The windshield cleaning system of claim 15, wherein the one or more nozzles operate simultaneously to project the high pressure air onto the outer surface of the windshield.

17. The windshield cleaning system as claimed in claim 15, wherein some of the plurality of nozzles are arranged at the bottom of the windshield and remaining nozzles are arranged on a side of a wiper blade.

18. The windshield cleaning system as claimed in claim 1, wherein each nozzle is adapted to generate a fan-shaped spray during vertical projection onto the windshield.

19. A method of cleaning a windshield of a vehicle, the method comprising:
applying a nano-hydrophobic coating and a photocatalytic coating on the windshield;
receiving information from one or more sensors configured to indicate the presence of an extraneous element present on the windshield;
activating a compressed air source in response to detection of extraneous elements by the one or more sensors;
activating a control valve by a control unit in response to the information received from the one or more sensors, wherein the control valve arranged in an air line between a compressed air source and a plurality of nozzles, and wherein the control valve is operable to move between closed and open positions to control a flow of compressed air through the air line; and
in response to the activation of the control valve, changing the position of the control valve from a closed position to an open position to allow the flow of compressed air towards the plurality of nozzles that are configured to spray the compressed air onto the outer face of the windshield along an air flow axis to remove extraneous elements present thereon.

20. A wiper system of an automotive vehicle comprising:
a wiper blade assembly;
a wiper arm assembly;
a linkage mechanism; and
a windshield cleaning system comprising:
a nano-hydrophobic coating and a photocatalytic coating, which is applied on an outer face of a windshield of an automotive vehicle;
a plurality of nozzles arranged at a bottom of the windshield;
one or more control valves arranged in an air line between a compressed air source and each nozzle of the plurality of nozzles;
one or more sensors operably connected with a compressed air source;
a control unit that operably connects the number of control valves and the compressed air source for automated operation of the control valves;
wherein the control unit is configured to select one or more nozzles from the plurality of nozzles for an operation based on the information from the one or more sensors; and
wherein the control valve changes from a closed position to an open position to allow a flow of compressed air towards one or more nozzles of the plurality of nozzles that are configured to spray the compressed air onto the outer face of the windshield along an air flow axis to remove extraneous elements present thereon in response to an activation signal from the control unit.
